(19) United States
(12) Patent Application Publication
(10) Pub. No.: US 2017/0128754 A1
(43) Pub. Date: May 11, 2017

(54) Wearable Apparatus

(71) Applicant: BOE Technology Group Co., Ltd., Beijing (CN)

(72) Inventor: Dianjie Hou, Beijing (CN)

(73) Assignee: BOE Technology Group Co., Ltd., Beijing (CN)

(21) Appl. No.: 15/129,926

(22) PCT Filed: Nov. 3, 2015
(86) PCT No.: PCT/CN2015/093704

§ 371 Date: Sep. 28, 2016

(30) Foreign Application Priority Data
May 27, 2015 (CN) 201510278623.X

(51) Int. Cl. A62B 23/02; A62B 7/10; A62B 18/08; A62B 18/00; A62B 18/02; A41D 13/11; A62B 9/00

(52) U.S. Cl. CPC A62B 23/025; A41D 13/11; A62B 7/10; A62B 9/006; A62B 18/003; A62B 18/02; A62B 18/08

(57) ABSTRACT

A wearable apparatus, comprising: a body capable of covering a mouth and/or a nose of a wearer wearing the apparatus, wherein, the body comprises: an air detection device for detecting quality of the air outside of the body. Users can be acknowledged the air quality condition, etc., by the wearable apparatus, and smart human-machine interaction function can be achieved.

### TECHNICAL FIELD

The embodiments of the present invention relate to a wearable apparatus.

### BACKGROUND

With development of science and technology, requirement on function of a wearable product is significantly increased. The function of the wearable product has been not limited to functions which a general wearable product can achieve any more, but is developed towards multifunctional and integral target.

The wearable production in the related art, e.g. a mouth mask, only has a general mouth mask function, the function is single, and therefore, can not meet the requirement of multifunctional wearable product. Even some products may be integrated with some simple functions, it has low smart degree, and can not achieve effective human-machine interaction. Moreover, the mouth masks in the market are mostly disposable, which will cause large resource waste.

### SUMMARY

A wearable apparatus is provided in the present invention, comprising: a body capable of covering a mouth and/or a nose of a wearer wearing the apparatus, wherein, the body comprises: an air detection device for detecting quality of the air outside of the body.

For example, wherein the body further comprises a notification device provided on the body and connected with the air detection device, the notification device is capable of notifying the wearer of detection data fed back from the air detection device.

For example, the notification device comprises a display screen for displaying the data detected by the air detection device.

For example, the display screen is a flexible display screen.

For example, the body further comprises a filter device detachably connected with the body.

For example, the filter device comprises: a filter screen and a filter screen support, the filter screen support is connected with the body, and the filter screen is detachably connected on the filter screen support.

For example, wherein the filter screen support is movably connected with the body.

For example, one side of the filter screen support is hinged with the body by a hinge.

For example, the filter screen support is detachably connected with the body.

For example, the air detection device comprises a temperature sensor, a humid sensor or a PM 2.5 detector.

For example, the air detection device further comprises a signal transmitting unit for sending the data detected by the air detection device to other apparatuses connected with the wearable apparatus.

For example, further including a suction device.

For example, wherein the suction device comprises a mini electric fan provided inside the body, and the mini electric fan is provided with its outlet side facing the mouth and the nose of the wearer.

For example, further comprising a power source for powering the wearable apparatus.

For example, wherein the power source is provided as a photovoltaic battery on an outer surface of the body or a external power source connected with the body by a wire.

For example, the apparatus further comprises a muffler device provided inside of the filter device.

For example, the muffler device is made of sound insulation material and has a surface in rough structure.

### BRIEF DESCRIPTION OF DRAWINGS

In order to more clearly describe the technical solution of the embodiments of the present invention, the attached drawings for the embodiments will be briefly described, it is obvious that the attached drawings in the following description only illustrate some embodiments of the present invention. For the skilled person in the art, without any inventive work, they can obtain other figures according to the drawings.

FIG. 1A and FIG. 1B are schematic front views of structure of a smart wearable apparatus according to an embodiment of the present invention;

FIG. 2 is a schematic side view of structure of a smart wearable apparatus according to an embodiment of the present invention; and

FIG. 3A and FIG. 3B are explored views showing a smart wearable apparatus according to embodiments of the present invention.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

In the description of the invention, it should be known that, the terms “center”, “up”, “down”, “before”, “after”, “left”, “right”, “vertical”, “horizontal”, “top”, “bottom”, “inside”, “outside” and the like, showing direction or position relationship, are all direction or position basing on the illustration of the drawings, and only for the convenience of describing the invention or simplify the description, but not for indicating or suggesting the pointed apparatuses or elements must have the special direction or be constructed or operated with the special position, thus they should not be considered a limitation of the invention. The terms “first”, “second” are only used to depict objective, should not be considered to indicate or suggest relative importance or imply the amount of the indicated technical features. Therefore, the features limited with “first”, “second” may indicate or imply including one or more the features. In the description of this invention, the meaning of “a plurality of ” is two or more than two except additional statement.

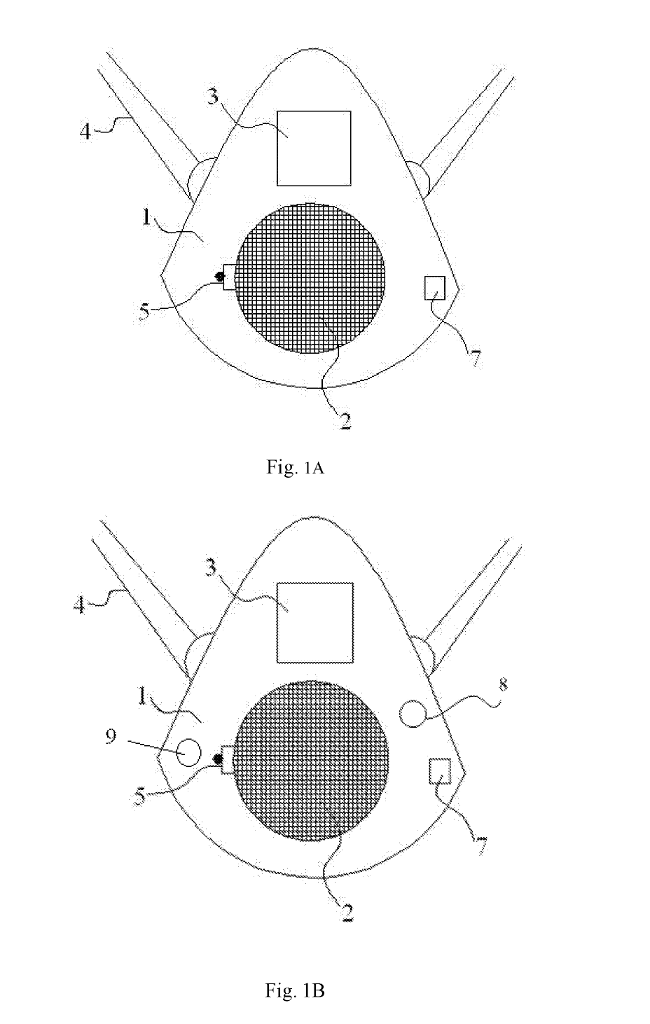

Referring to FIG. 1, FIG. 1A and FIG. 1B show a particular embodiment of a smart wearable apparatus of the present invention. The smart wearable apparatus in the embodiment includes a body 1 for covering a mouth and a nose of a wearer, the body 1 is provided with a detachable filter device 2. For example, the filter device 2 can be a filter layer, for example, a layered filter film, a layered filter paper, a layered filter screen, or the like; can also be formed by adding filter material on the material of the body 1, and can also be a filter having automatic filter function. For example, the body 1 is provided with an air detection unit 8 (shown in FIG. 1B) for detecting air quality at a position adjacent to the filter device 2, and the body 1 is also provided with a notification device at its outer surface. When the air detection unit 8 detects that the ambient air has poor quality, a notification can be sent to the user in alarm, voice, image, etc. ways. For example, the notification device can be a display screen 3, the display screen 3 is connected with the air detection unit 8, and the display screen 3 may display monitor data fed back from the air detection unit 8. The notification device can also be a speaker, a vibration element, a LED lamp, or the like.

For the smart wearable apparatus provided by the embodiment of the present invention, when wearing, the wearer can cover the body 1 over his mouth and nose, and then fix a tether 4 on his ears or head, to complete wearing. Since the wearer needs breath by the mouth and the nose, for the wearable apparatus such as a mouth mask, a face mask, or the like, after being used for a relative long time, dust will accumulated at positions corresponding to the mouth and the nose of the wearer, and thus the filter effect will be degraded. In the embodiment of the present invention, the filter device 2 is detachably so that the wearer can easily detach the failed filter device 2 for changing, it is avoided that the wearable apparatus is changed as a whole, and thus the resource is saved. In addition, the body 1 can still be provided with an air detection unit 8 for detecting air quality near the filter device 2. The position of the air detection unit shown in FIG. 1B is only a schematic provision position, and the air detection unit 8 can be provided at various positions at outside, inside, or a side of the body 1, or the like, so that the air detection unit can contact with ambient air and detect the air. The notification device, e.g. a display screen 3 is provided on an outer surface of the mask body 1, the display screen 3 is connected with the air detection unit 8, and the display screen 3 can display monitor data fed back from the air detection unit 9, whereby, the user can acknowledge the air quality in real time, so that the user can be notified of wearing the apparatus, such as mouth mask and so on in time, and thus a smart human-machine interaction can be achieved. When the user is wearing the mouth mask, the display screen 3 may further display some other information, e.g. emotion of the user, whereby, when the user is wearing the mouth mask, the display screen may display smile emotion, travel entertainment of the user can be improved.

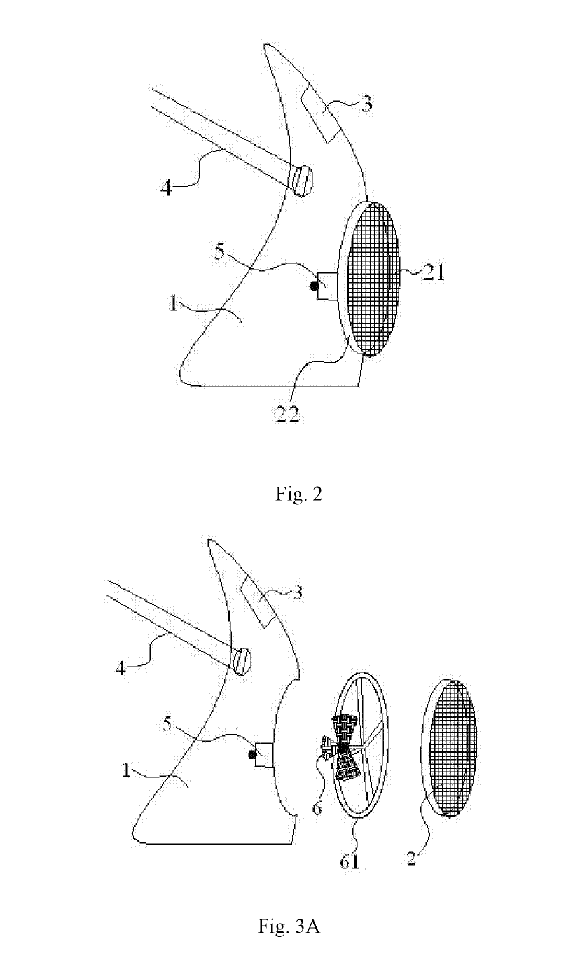

According to one example of the present invention, referring to FIG. 2, when the filter device 2 is a filter layer, the filter device 2 can include a filter screen 21 and a filter screen support 22. Since the filter screen 21 is soft, and is difficult to keep its shape, it is preferably to connect the filter screen 21 with the body 21 through the filter screen support 22. Optionally, the filter screen support 22 is of ring shape and connected with the body 1. The filter screen 21 is detachably connected to a ring shaped opening of the filter screen support 22. For example, the body 1 can be provided with a through hole having a profile matched with the filter screen support 22 at its middle part, then the filter screen support 22 is connected with the through hole, and finally, edges of the filter screen 21 are adhered with the filter screen support 22. Thus, the filter screen 21 can be kept in a constant shape, which can prevents from being deformed when in used so as to affect its filter effect.

In an example of the embodiment of the present invention, the filter screen support 22 can be connected with the body 1 in various ways. For example, the filter screen support 22 can be movably fitted with the body 1, that is, the filter screen support 22 can be moved with respect to the body 1, as shown in FIG. 1A, the filter screen support 22 can be hinged with the body 1 through a hinge 5 at one side thereof. When the filter screen 1 is needed to be changed, what is needed to do is only rotating the filter screen support 22 along the hinge 5 so as to open the filter screen support 22 and making the inner side of the filter screen support 22 to face outward, and then, the filter screen 21 provided inside of the filter screen support 22 can be easily changed. In addition, the filter screen support 22 can be detachably connected with the body 1, for example, two of them are engaged to each other by an engaged connecting structure. For example, two sides of the filter screen support 22 are provided with snap grooves, and the body 1 is provided with two elastic snap joints, and then the filter screen support 22 can be detachably connected with the body 1 by fitting the snap grooves with the snap joints. In addition, the filter screen support 22 can be connected with the body 1 by screw connection, for example, a ring shaped protrusion is provided at the through hole of the body 1, and a male thread is provided at an outer surface of the ring shaped protrusion, then the filter screen support 22 is formed into a cylinder shape, and a female thread matched with the above male thread is provided on an inner surface of the cylindrical filter screen support 22. Thus, upon assembly, what is to be done is to screw the female thread and the male thread. By the screw connection, the filter screen support 22 can be easily mounted, and protrusion height of the filter screen support 22 can be adjusted by the threads.

In order to enable the wearable apparatus provided by the embodiment of the present invention to better fit with the face of the user, the display screen 3 is preferably a flexible display screen. Due to flexible character, the flexible display screen can be bent according to the profile of the human face, and thus when the user wears it on his face, it can be better fit with the profile of the face of the user.

For example, the air detection unit 8 may include a temperature sensor, a humid sensor and a PM 2.5 sensor, or any one of these sensors or their combination. PM 2.5 is the particles having a diameter less than or equal with 2.5 micrometer in the air. Thus, by the air detection unit 8, air temperature, air humid and PM 2.5 value of the air can be detected. After that, these monitor results can be provided to the user through the notification device, so that the wearer can wear the wearable apparatus such as the mouth mask according to the air condition in time.

Optionally, the wearable apparatus provided by the embodiment of the present invention may have a signal transmitting unit 9 (shown in FIG. 1B), thus, it is possible to achieve that the information of a smart wearable apparatus can be matched with other terminals, such as a smart phone, a wristband, and so on. The air quality information, weather information, etc. detected by the smart wearable apparatus can be sent to the other smart terminals, such as the smart phone, the wrist band, and so on. The residual amount of contamination on the mask filter device 2 can be displayed on the smart phone, the wristband, so that the user can easily acknowledge the environment information at anywhere and anytime, wear the wearable apparatus in time, or change the filter device 2 in the wearable apparatus.

The signal transmitting unit 9 can transmit signals in wired manner or wireless manner. When transmitting in wired manner, the air detection unit 8 is provided with a connection interface, and the connection interface is used to connect the air detection unit 8 with an external smart terminal. When transmitting in wireless manner, Bluetooth, wireless local area network, infrared transmission, etc. can be used.

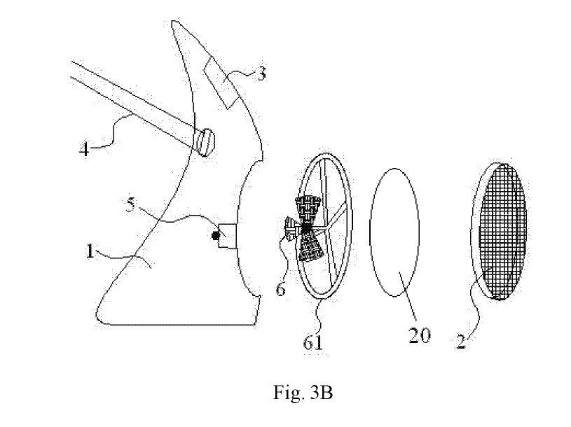

Since the wearer need to breath with his mouth and nose, after wearing the mouth mask, breath becomes difficult due to blocking effect of the mouth mask, especially, the breath will become even more difficult when carrying out aerobic exercise. In order to solve this problem, as shown in FIG. 3A, it is preferable that a suction device can be provided inside of the filter device 2, for example, a mini electric fan 6 can be provided, and the mini electric fan 6 is provided with its outlet side facing the mouth and nose of the wearer, so that the mini electric fan 6 blows to the wearer. Thus, not only the filter effect can be improved, but also sufficient amount of air can be supplied to the inside of the mouth mask body 1, which can meet the situation having increased oxygen demand. The mini electric fan 6 can be connected with the body 1 or the filter screen support 22 by a fan bracket 61.

For example, the mini electric fan 6 can be powered by a mini power source (e.g. a primary battery or a secondary batter) included in the smart wearable apparatus. In order to reduce weight, the embodiments of the present invention can also be externally provided with a mini power source which is connected with the mouth mask body by a wire. The mini power source can be put in a pocket of cloth. As shown in FIG. 1, a photovoltaic battery panel 7 is provided at the outer surface of the body 1, and electric power converted by the photovoltaic battery panel 7 can be used to power the mini electric fan 6. Similarly, the photovoltaic battery panel 7 can also power the display screen 3 and the air detection unit 8, thus, the solar energy can be used, and object of saving energy can be achieved.

The wearable apparatus according to an embodiment of the present invention may further include a muffler device, e.g. a muffler layer, as shown in FIG. 3B, the muffler layer can be provided on an inner side of the filter screen 21. Thus, when the wearer read some documents loud in public, such as on a bus, the voice generated upon reading can be prevented from transmitting outside to influence on others, especially suitable to be worn by students. The muffler device can be provided by providing a muffler layer inside or outside of the body, the muffler layer can be made from sound insulation material, e.g. sound insulation cotton, and it is preferable that the muffler layer has a surface formed as rough structure, by which sound waves can be reflected multiple times, thus the sound can be dampened gradually and the sound insulation effect can be further improved.

It is preferable that the filter device 2 is made by material capable of filtering particles having a diameter less than or equal with 2.5 micrometer. For example, the material for the filter device 2 is a nuclear pore film, the nuclear pore film has a lot of micro holes thereon, has very high hole density, and thus can filter most of particles. In addition, there are some function groups on surfaces and hole walls of the nuclear pore film, these function groups can function to effectively block PM 2.5 with efficiency over 98%.

For example, the body 1 is formed by a material which is preferably light plastic, the light plastic has low weight and also has a certain ductility, therefore, can better attach with the profile of the user face.

The smart wearable apparatus provided by the embodiments of the present invention can be a mouth mask type wearable product, and also can be a face mask product, a scarf type product, and so on, all these should be fallen within the protection subject of the present invention, as long as the product itself has a function of covering the mouth and nose.

In the smart wearable apparatus provided by the embodiments of the present invention, a detachable filter layer is provided on the body at the portion corresponding to the mouth and the nose of the wearer. Since the user often breath with the mouth and the nose, for the wearable apparatus such as a mouth mask, a face mask, etc., after being used for a long time, dust will be accumulated at the positions corresponding to the mouth and the nose of the wearer, thus the filter effect will be degraded. However, in the embodiments of the present invention, the filter layer is provided as a detachable structure, so that the wearer can easily change the failed filter layer, it is avoided to change the entire wearable apparatus, and thus resource is saved. In addition, an air detection unit for detecting air quality is provided on the body near the filter layer, and for example, a display screen is provided on an outer surface of the mouth mask, the display screen is connected with the air detection unit, and can display the monitor data fed back from the air detection unit, whereby the user can acknowledge the air quality condition in real time, and can be notified to wear the wearable apparatus like the mouth mask in time, and thus smart human-machine interaction can be achieved.

In the description, the particular features, structures, materials or characters can be suitably combined in any one or more embodiments or examples.

The present application claims the priority of Chinese Patent Application No. 201510278623.X filed on May 27, 2015, the Chinese Patent Application is entirely incorporated therein as a part of the present application by reference.

1. A wearable apparatus comprising:
a body capable of covering a mouth and/or a nose of a wearer wearing the apparatus, wherein, the body comprises:
an air detection device for detecting quality of the air outside of the body.

2. The wearable apparatus according to claim 1, wherein the body further comprises a notification device provided on the body and connected with the air detection device, the notification device is capable of notifying the wearer of detection data fed back from the air detection device.

3. The wearable apparatus according to claim 2, wherein the notification device comprises a display screen for displaying the data detected by the air detection device.

4. The wearable apparatus according to claim 3, wherein the display screen is a flexible display screen.

5. The wearable apparatus according to claim 1, wherein the body further comprises a filter device detachably connected with the body.

6. The wearable apparatus according to claim 5, wherein the filter device comprises: a filter screen and a filter screen support, the filter screen support is connected with the body, and the filter screen is detachably connected on the filter screen support.

7. The wearable apparatus according to claim 6, wherein the filter screen support is movably connected with the body.

8. The wearable apparatus according to claim 7, wherein one side of the filter screen support is hinged with the body by a hinge.

9. The wearable apparatus according to claim 6, wherein the filter screen support is detachably connected with the body.

10. The wearable apparatus according to claim 1, wherein the air detection device comprises a temperature sensor, a humid sensor or a PM 2.5 detector.

11. The wearable apparatus according to claim 1, wherein the air detection device further comprises a signal transmitting unit for sending the data detected by the air detection device to other apparatuses connected with the wearable apparatus.

12. The wearable apparatus according to claim 1, further including a suction device.

13. The wearable apparatus according to claim 12, wherein the suction device comprises a mini electric fan provided inside the body, and the mini electric fan is provided with its outlet side facing the mouth and the nose of the wearer.

14. The wearable apparatus according to claim 1, further comprising a power source for powering the wearable apparatus.

15. The wearable apparatus according to claim 14, wherein the power source is provided as a photovoltaic battery on an outer surface of the body or a external power source connected with the body by a wire.

16. The wearable apparatus according to claim 5, wherein the apparatus further comprises a muffler device provided inside of the filter device.

17. The wearable apparatus according to claim 14, wherein the muffler device is made of sound insulation material and has a surface in rough structure.
